(19) United States
(12) Patent Application Publication
(10) Pub. No.: US 2026/0134007 A1
(43) Pub. Date: May 14, 2026

(54) INFORMATION PROCESSING DEVICE, INFORMATION PROCESSING METHOD, AND INFORMATION PROCESSING PROGRAM

(71) Applicant: LY Corporation, Tokyo (JP)

(72) Inventors: Kazuhiro NINOMIYA, Tokyo (JP); Reiya YAMAGUCHI, Tokyo (JP)

(21) Appl. No.: 19/278,654

(22) Filed: Jul. 23, 2025

(30) Foreign Application Priority Data
Nov. 14, 2024 (JP) 2024-198858

(51) Int. Cl. G06F 16/3329; G06F 16/387

(52) U.S. Cl. CPC G06F 16/33295; G06F 16/387

(57) ABSTRACT

The information processing device according to an embodiment of the present disclosure includes the acceptance unit that accepts a question from a user; the determination unit that determines an answer generation agent from among a plurality of answer generation agents trained to respond based on different answer policies and linked in a hierarchical structure in accordance with a predetermined event, the selected agent being the one that corresponds to the question; and the generation unit that generates an answer to the question using the determined answer generation agent.

### CROSS-REFERENCE TO RELATED APPLICATIONS

The present application claims priority to and incorporates by reference the entire contents of Japanese Patent Application No. 2024-198858 filed in Japan on Nov. 14, 2024.

### BACKGROUND OF THE INVENTION

### 1. Field of the Invention

The present invention relates to an information processing device, an information processing method, and an information processing program.

### 2. Description of the Related Art

Conventionally, services are known that provide appropriate search results as answers to search queries entered by a user (see, e.g., JP 2022-188759 A).

However, in conventional techniques, there remains room for improvement in terms of providing an appropriate answer to a question such as search queries from a user.

### SUMMARY OF THE INVENTION

An information processing device according to an embodiment of the present disclosure includes the acceptance unit that accepts a question from a user; the determination unit that determines an answer generation agent from among a plurality of answer generation agents trained to respond based on different answer policies and linked in a hierarchical structure in accordance with a predetermined event, the selected agent being the one that corresponds to the question; and the generation unit that generates an answer to the question using the determined answer generation agent.

### BRIEF DESCRIPTION OF THE DRAWINGS

FIG. 1A is a diagram illustrating processing executed by an information processing device according to an embodiment;

FIG. 1B is a diagram illustrating an example of an answer provided by an information processing device according to an embodiment;

FIG. 2 is a block diagram illustrating an exemplary configuration of an information processing system according to an embodiment;

FIG. 3 is a diagram illustrating an exemplary configuration of an information processing device according to an embodiment;

FIG. 4 is a diagram illustrating an example of user information;

FIG. 5 is a diagram illustrating an example of AG information;

FIG. 6 is a flowchart illustrating a processing procedure of processing executed by an information processing device according to an embodiment; and

FIG. 7 is a diagram illustrating an example of a hardware configuration.

### DETAILED DESCRIPTION OF THE PREFERRED EMBODIMENTS

Hereinafter, embodiments for implementing an information processing device, an information processing method, and an information processing program according to the present disclosure (collectively referred to as “embodiment” hereinafter) will be described in detail with reference to the drawings. Moreover, the information processing device, information processing method, and information processing program according to the present disclosure are not limited to the embodiments described herein. In addition, the same reference numerals are assigned to the same components across different embodiments, and redundant descriptions are omitted.

### Embodiment

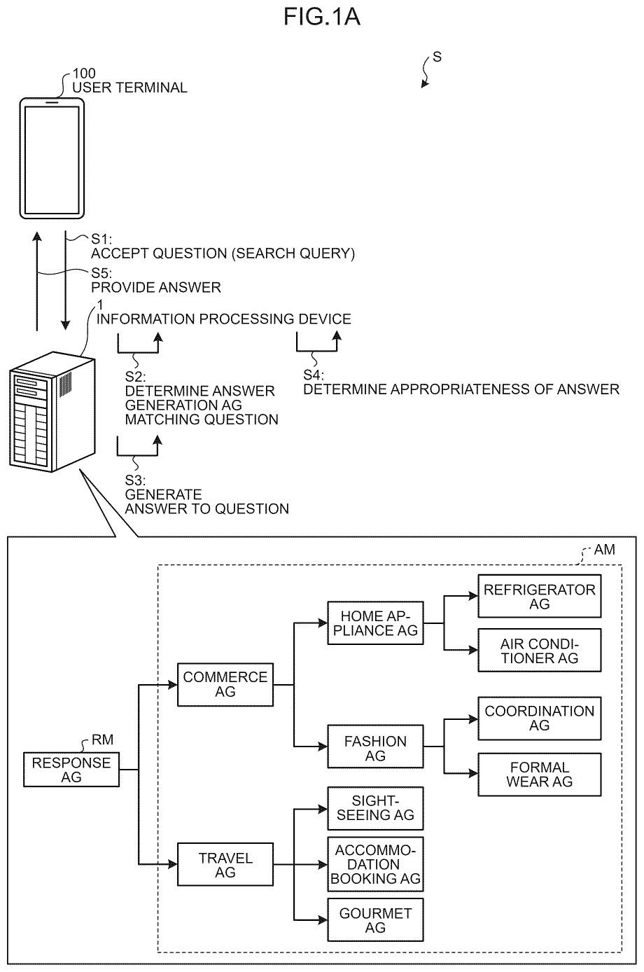

First, the processing executed by an information processing device according to the present embodiment is now described with reference to FIGS. 1A and 1B. FIG. 1A is a diagram illustrating the processing executed by the information processing device according to the present embodiment. FIG. 1B is a diagram illustrating an example of an answer provided by the information processing device according to the present embodiment. Moreover, FIG. 1A illustrates an exemplary operation of an information processing system S including an information processing device 1 according to the present embodiment.

As illustrated in FIG. 1A, the information processing system S according to the present embodiment includes the information processing device 1 and a user terminal 100.

As illustrated in FIG. 1A, the information processing system S according to the present embodiment accepts a question from a user, determines an answer generation agent matching the question from among a plurality of answer generation agents, each of which is trained to generate an answer based on a different answer policy and is linked in a hierarchical structure for each predetermined event, and generates an answer to the question using the determined answer generation agent. Moreover, in the following, “agent” will be referred to as “AG”.

Specifically, the information processing device 1 first accepts a user question from the user terminal 100 (step S1). For example, the information processing device 1 accepts a search query for searching a predetermined event as a question. For example, the information processing device 1 accepts conversational text entered by a user in a chat format as a search query. The information processing device 1 can accept not only text but also images, audio, or the like as a question. In addition, the information processing device 1 can, for example, accept a search query entered by a user in a search service as a question.

The predetermined event can be abstract content to some extent, such as commerce or travel, or can be specific content, such as home appliances or sightseeing. In other words, the predetermined event can be abstract content, such as a category, or specific content, such as a product name.

Then, the information processing device 1 determines an answer generation AG that matches the question (step S2). Specifically, the information processing device 1 stores in advance a response agent (AG) RM, which is a trained model, and a plurality of answer generation agents (AGs) AM, each having a different answer policy for a predetermined event, and the response AG RM determines an answer generation AG AM with an answer policy suitable for responding to the question from among the answer generation AGs AM.

The response AG RM is, for example, configured with large language models (LLMs) and is a model trained to make an appropriate answer to an input question. Specifically, the response AG RM is trained to analyze the input question to grasp the content of the question (e.g., event) and to determine an answer generation AG AM with an answer policy capable of generating an appropriate answer to the grasped content of the question. For example, the response AG RM learns in advance the answer policies that each answer generation AG AM can handle, and from the learned answer policies, determines an answer generation AG AM with an answer policy that matches the content of the question.

The multiple answer generation AGs AM are, for example, configured with LLMs and are models trained to generate an answer to the input query in accordance with a specific answer policy. Each of the multiple answer generation AGs AM has a different answer policy for a predetermined event. In FIG. 1A, commerce related to electronic transactions and travel related to trip or tourism are illustrated as the predetermined events. As illustrated in FIG. 1A, the multiple answer generation AGs AM are linked in a hierarchical structure for each predetermined event. The response AG RM is linked to the first-tier answer generation AG AM among the multiple answer generation AGs AM.

In commerce, which is one of the predetermined events, a commerce AG is arranged in the first tier, a home appliance AG and a fashion AG are arranged in the second tier, and a refrigerator AG, an air conditioner AG, a coordination AG, and a formal wear AG are arranged in the third tier. The home appliance AG and the fashion AG in the second tier are linked to the commerce AG in the first tier. The refrigerator AG and the air conditioner AG in the third tier are linked to the home appliance AG in the second tier, and the coordination AG and the formal wear AG are linked to the fashion AG. In other words, the multiple answer generation AGs are arranged in lower tiers as their answer policy scope becomes narrower.

The commerce AG is a model that employs an answer policy covering commerce in general. In other words, the commerce AG is not a model specialized in generating an answer regarding specific products, but rather a model that generates an answer to broad queries, such as “What is the return policy in commerce?”. The home appliance AG is a model that employs an answer policy covering home appliances. The fashion AG is a model that employs an answer policy covering fashion. The refrigerator AG is a model that employs an answer policy covering refrigerators. The air conditioner AG is a model that employs an answer policy covering air conditioners. The coordination AG is a model that employs an answer policy covering outfit styling. The formal wear AG is a model that employs an answer policy covering formal wear.

Furthermore, for travel, which is one of the predetermined events, the travel AG is placed in the first tier, and the sightseeing AG, the accommodation booking AG, and the gourmet AG are placed in the second tier. The sightseeing AG, the accommodation booking AG, and the gourmet AG in the second tier are linked to the travel AG in the first tier.

The travel AG is a model that employs an answer policy covering travel in general. The sightseeing AG is a model that employs an answer policy covering sightseeing-related topics. The accommodation booking AG is a model that employs an answer policy covering booking accommodations. The gourmet AG is a model that employs an answer policy covering gourmet-related topics.

Moreover, in FIG. 1A, an example is illustrated in which commerce is configured up to the third tier and travel is configured up to the second tier, but the system can be configured with four or higher tiers, and the number of tiers for each event can be different as illustrated in FIG. 1A, or can be aligned to have the same number of tiers.

The information processing device 1 provides the input question to the response AG RM. The response AG RM analyzes the question to identify an event indicated by the content of the question and determines an answer generation AG in the first tier that matches the identified event. For example, if the question relates to commerce, the information processing device 1 selects the commerce AG. Moreover, if the question relates to a refrigerator, the information processing device 1 can determine the commerce AG in the first tier or can directly determine the refrigerator AG in the third tier. Moreover, even if the information processing device 1 determines the commerce AG in the first tier for a question regarding a refrigerator, it is determined as inappropriate by a later appropriateness determination of the answer, and then gradually changed to deeper tiers, such as the second tier and the third tier, to generate an appropriate answer.

Further, the response AG RM can determine the answer generation AG AM by considering user information regarding a user who inputs the question. In other words, the response AG RM determines the answer generation AG AM based on the question and the user information.

For example, the response AG RM determines the answer generation AG AM based on the question and the location history of a user. For example, in FIG. 1A, if the sightseeing AG is divided by region on the lower side (third tier) of the sightseeing AG, the response AG RM identifies the current location from the user's location history and determines the regional sightseeing AG that matches the current location. Furthermore, in addition to the location history, the answer generation AG AM can also be determined based on attribute information, which is the user information.

Further, the response AG RM can also determine the answer generation AG AM based on the question and a history of questions. For example, if there is a history of questions regarding Japanese pub (izakaya in Japanese), and the latest question is input as “What are the business hours?”, meaning a question for which the business hours are unclear, the response AG RM determines an answer generation AG (not illustrated) that employs an answer policy covering the business hours of the izakaya.

Subsequently, the information processing device 1 causes the determined answer generation AG to generate an answer to the question (step S3). Specifically, the information processing device 1 inputs the question to the answer generation AG determined from the response AG RM, and causes the answer generation AG to output (generate) an answer.

Subsequently, the information processing device 1 determines whether the generated answer is appropriate (step S4). Specifically, the response AG RM determines whether the generated answer is appropriate. More specifically, the response AG RM calculates a score indicating the degree of appropriateness of the generated answer and determines that the answer is appropriate if the score is higher than or equal to a threshold. The response AG RM, for example, analyzes the answer using an LLM and calculates, as a score, the degree of matching between the content of the answer and the content of the question. For example, the response AG RM calculates, as a score, the degree of matching between the category of the event indicated by the answer and the category of the event indicated by the question. For example, if the category of the event indicated by the answer is related to “commerce in general” and the category of the event indicated by the question is related to “refrigerator”, the score is calculated to be low, meaning it is determined to be inappropriate.

The information processing device 1, if it is determined that the answer is inappropriate, redetermines another answer generation AG and causes a new answer to be generated. For example, if the response AG RM determines that the answer is not appropriate, the response AG RM determines a lower-tier answer generation AG, causes the determined lower-tier answer generation AG to generate an answer, and then determines whether the generated answer is appropriate. For example, if the answer generated by the commerce AG is determined to be inappropriate, questions can be input to each of the second-tier home appliances AG and the fashion AG, causing them to generate answers. In this case, if the answers generated by the home appliances AG and the fashion AG are both inappropriate, the response AG RM can cause the lower-tier answer generation AGs AM (refrigerator AG, air conditioner AG, coordination AG, and formal wear AG) of the home appliances AG and the fashion AG, respectively, to generate an answer, or can cause the lower-tier answer generation AG with the higher score between the home appliances AG and the fashion AG to generate an answer.

Subsequently, if the generated answer is determined to be appropriate, the information processing device 1 provides the answer to the user terminal 100 (step S5). Specifically, the response AG RM provides all answers with a score higher than or equal to the threshold to the user terminal 100. Alternatively, the response AG RM can provide only the answer with the highest score among the answers with a score higher than or equal to the threshold to the user terminal 100.

An example of an answer provided by the information processing device 1 is now described with reference to FIG. 1B. In FIG. 1B, a question “Tell me about izakaya in Echigo-Yuzawa (a region in Japan)?” is input, and the answers to that question are given as examples.

In the example illustrated in FIG. 1B, the information processing device 1 provides four answers that are determined to be appropriate. Each of the four answers originates from a different answer generation AG. In the case where the user operates the user terminal 100 to select one of the answers, the information processing device 1 displays the selected answer.

Further, as illustrated in FIG. 1B, the screen that displays an answer is in a chat format, allowing the user to ask additional queries following an answer.

As described above, the information processing device 1 according to the present embodiment makes it possible to provide an appropriate answer to a question by determining, from among a plurality of answer generation AGs AM linked in a hierarchical structure for each predetermined event, an answer generation AG that matches the question and causing that agent to generate an answer, thereby enabling the provision of an appropriate answer to the question through the answer generation AG.

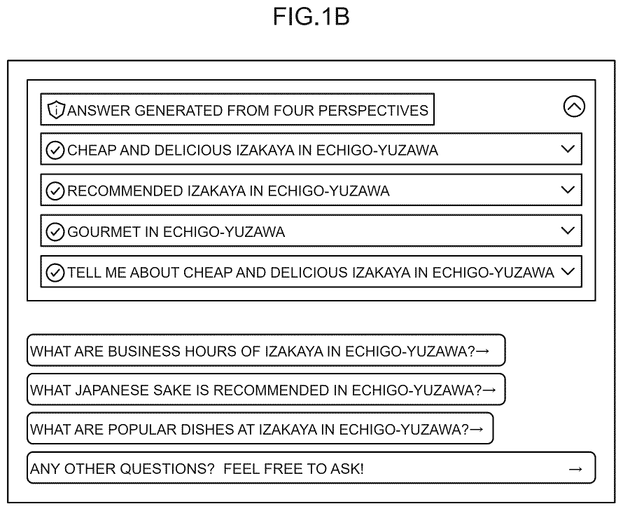

Next, with reference to FIG. 2, an exemplary configuration of the information processing system S according to the present embodiment is described. FIG. 2 is a block diagram illustrating an exemplary configuration of the information processing system S according to the present embodiment. As illustrated in FIG. 2, in the information processing system S according to the present embodiment, the information processing device 1 and a plurality of user terminals 100 are connected to a network N via wired or wireless communication. The network N is, for example, the Internet, a wide area network (WAN), a local area network (LAN), or the like.

The information processing device 1 is a server device that executes an information processing method according to the present embodiment. The information processing device 1 accepts a question from a user, determines an answer generation agent matching the question from among multiple answer generation agents which are trained to provide an answer based on different answer policies and are linked in a hierarchical structure for each predetermined event, and causes the determined answer generation agent to generate an answer to the question.

Further, the information processing device 1 is an information processing device that cooperates with the plurality of user terminals 100 and provides various types of data and application programming interface (API) services for various applications (hereinafter referred to as apps) to the plurality of user terminals 100, and is implemented by a server device, a cloud system, or the like.

Additionally, the information processing device 1 can also be an information processing device that provides some kind of Web services online to the plurality of user terminals 100. For example, as a Web service, the information processing device 1 can provide services such as Internet connection, search services, social networking service (SNS), electronic commerce (EC), electronic payment, online games, online banking, online trading, accommodation and ticket reservations, video and music distribution, news, maps, route searches, navigation, transit route information, transportation status information, and weather forecasts, and the like. In practice, the information processing device 1 can cooperate with various servers that provide the above-mentioned Web services and mediate the Web services or it can be responsible for processing the Web services.

The user terminal 100 is a terminal device held by a user. The user terminal 100 can be any type of terminal devices, such as a smartphone, a desktop PC, a laptop PC, a tablet PC, or the like. The user terminal 100 transmits various types of information to the information processing device 1 or the like and receives information provided by the information processing device 1 or the like.

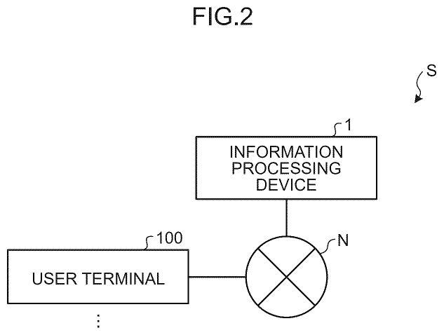

Next, with reference to FIG. 3, an exemplary configuration of the information processing device 1 is described.

FIG. 3 is a diagram illustrating an exemplary configuration of the information processing device 1 according to the present embodiment. As illustrated in FIG. 3, the information processing device 1 includes a communication unit 2, a control unit 3, and a storage unit 4. The control unit 3 includes an acceptance unit 31, a determination unit 32, a generation unit 33, and a provision unit 34. The storage unit 4 stores user information 41 and AG information 42.

The communication unit 2 is implemented, for example, by a network interface card (NIC) or the like. The communication unit 2 is connected to a network infrastructure via wired or wireless communication.

The control unit 3 is a controller, and is implemented, for example, by a processor such as a central processing unit (CPU) or micro processing unit (MPU) executing various programs (corresponding to an example of an information processing program) stored in a storage unit within the information processing device 1 using a RAM or the like as a working area. Additionally, the control unit 3 is a controller, and can be implemented by an integrated circuit such as an application-specific integrated circuit (ASIC), a field-programmable gate array (FPGA), or a general-purpose graphic processing unit (GPGPU).

The storage unit 4 is implemented by a semiconductor memory device such as random-access memory (RAM) or flash memory, or a storage device such as a hard disk or an optical disk.

The user information 41 is information regarding a user.

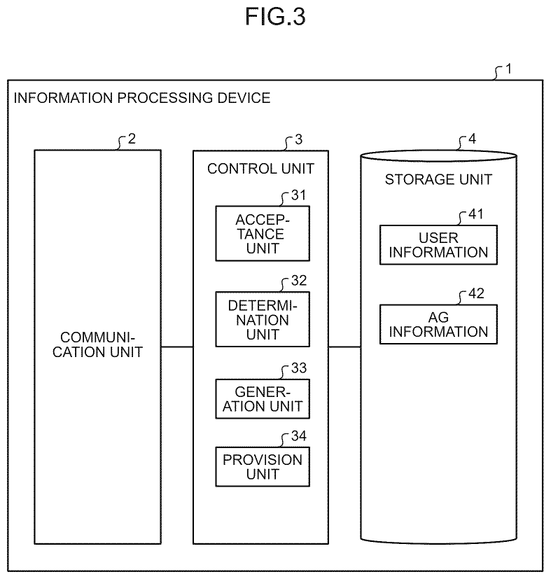

FIG. 4 is a diagram illustrating an example of the user information 41. As illustrated in FIG. 4, the user information 41 includes items such as “user ID”, “attribute information”, and “behavioral information”.

The “user ID” is identification information that identifies a user. The “attribute information” is information regarding the attributes of a user. The attribute information includes, for example, psychographic attributes and demographic attributes. The “behavioral information” is information regarding the behavioral history of the user, including search behavior, purchasing behavior, visiting behavior, browsing behavior of articles and posted information, location information history, and the like.

The AG information 42 is information regarding the answer generation AG.

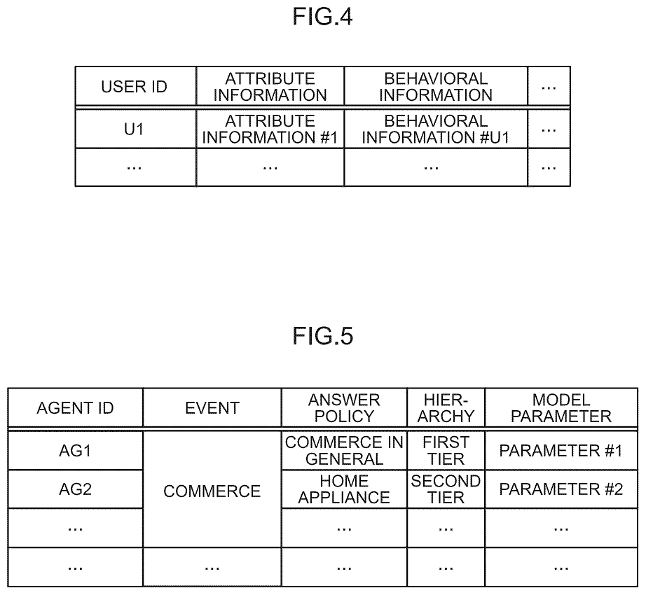

FIG. 5 is a diagram illustrating an example of the AG information 42. As illustrated in FIG. 5, the AG information 42 includes items such as “agent ID”, “event”, “answer policy”, “hierarchy”, “model parameter”, or the like.

The “agent ID” is identification information used for identifying an agent (including both the response AG and the answer generation AG). The “event” is information indicating an event linked to the answer generation AG. The “answer policy” is information indicating an answer policy in a predetermined event of the answer generation AG. The “hierarchy” is information indicating the tier at which the answer generation AG is located in the hierarchical structure. The “model parameter” is information indicating a parameter of the learning model of the answer generation AG.

Next, the functions of the control unit 3 of the information processing device 1 (the acceptance unit 31, the determination unit 32, the generation unit 33, and the provision unit 34) are described.

The acceptance unit 31 accepts various types of information. The acceptance unit 31 accepts a question of the user from the user terminal 100. For example, the acceptance unit 31 accepts a search query regarding a predetermined event as a question. For example, the acceptance unit 31 accepts the text input by the user in a chat format as a search query. The acceptance unit 31 can also accept, as a question, not only text but also images, sounds, and the like. In addition, the acceptance unit 31 can accept, for example, a search query input by the user in a search service as a question.

The determination unit 32 selects or determines an answer generation AG that matches a question. Specifically, the determination unit 32 stores in advance a response agent (AG) RM, which is a trained model, and multiple answer generation agents (AGs) AM, each having a different answer policy for a predetermined event, and the response AG RM determines an answer generation AG AM with an answer policy that can provide an appropriate answer to the question from among the answer generation AGs AM. The determination unit 32 inputs the entered question to the response AG RM. The response AG RM analyzes the question to identify an event indicated by the content of the question and determines an answer generation AG in the first tier that matches the identified event. For example, if the question relates to commerce, the determination unit 32 determines the commerce AG. Moreover, if the question relates to a refrigerator, the determination unit 32 can determine either the first-tier commerce AG or directly determine the third-tier refrigerator AG. In addition, even in the case where the determination unit 32 initially determines the first-tier commerce AG for a question related to a refrigerator, if it is later determined to be inappropriate by a subsequent appropriateness determination of the answer, the system gradually changes to deeper tiers, such as second tier or third tier to generate a more appropriate answer.

Further, the response AG RM can determine the answer generation AG AM by considering user information regarding a user who inputs the question. In other words, the response AG RM determines the answer generation AG AM based on the question and the user information.

For example, the response AG RM determines the answer generation AG AM based on the question and the location history of a user. For example, in FIG. 1A, if the sightseeing AG is divided by region on the lower side (third tier) of the sightseeing AG, the response AG RM identifies the current location from the user's location history and determines the regional sightseeing AG that matches the current location. Furthermore, in addition to the location history, the answer generation AG AM can also be determined based on attribute information, which is the user information.

Further, the response AG RM can also determine the answer generation AG AM based on the question and a history of questions. For example, if there is a history of questions regarding Japanese pub (izakaya in Japanese), and the latest question is input as “What are the business hours?”, meaning a question for which the business hours are unclear, the response AG RM determines an answer generation AG (not illustrated) that employs an answer policy covering the business hours of the izakaya.

The generation unit 33 generates an answer to the question. Specifically, the generation unit 33 causes the determined answer generation AG to generate an answer to the question. More specifically, the generation unit 33 inputs a question into the determined answer generation AG from the response AG RM and causes the answer generation AG to output (generate) an answer. Additionally, the generation unit 33 also determines whether the generated answer is appropriate. Specifically, the generation unit 33 causes the response AG RM to determine whether the generated answer is appropriate. Specifically, the response AG RM determines whether the generated answer is appropriate. More specifically, the response AG RM calculates a score indicating the degree of appropriateness of the generated answer and determines that the answer is appropriate if the score is higher than or equal to a threshold. The response AG RM, for example, analyzes the answer using an LLM and calculates, as a score, the degree of matching between the content of the answer and the content of the question. For example, the response AG RM calculates, as a score, the degree of matching between the category of the event indicated by the answer and the category of the event indicated by the question. For example, if the category of the event indicated by the answer is related to “commerce in general” and the category of the event indicated by the question is related to “refrigerator”, the score is calculated to be low, meaning it is determined to be inappropriate.

If it is determined to be inappropriate, the generation unit 33 redetermines another answer generation AG and causes the answer generation AG to generate a response again. For example, if the response AG RM determines that the answer is not appropriate, the response AG RM determines a lower-tier answer generation AG, causes the determined lower-tier answer generation AG to generate an answer, and then determines whether the generated answer is appropriate. For example, if the answer generated by the commerce AG is determined to be inappropriate, questions can be input to each of the second-tier home appliances AG and the fashion AG, causing them to generate answers. In this case, if the answers generated by the home appliances AG and the fashion AG are both inappropriate, the response AG RM can cause the lower-tier answer generation AGs AM (refrigerator AG, air conditioner AG, coordination AG, and formal wear AG) of the home appliances AG and the fashion AG, respectively, to generate an answer, or can cause the lower-tier answer generation AG with the higher score between the home appliances AG and the fashion AG to generate an answer.

If the generated answer is determined to be appropriate, the provision unit 34 provides the answer to the user terminal 100. Specifically, the provision unit 34 provides all answers with the above-mentioned score higher than or equal to the threshold to the user terminal 100 through the response AG RM. Alternatively, the response AG RM can provide only the answer with the highest score among the answers with a score higher than or equal to the threshold to the user terminal 100.

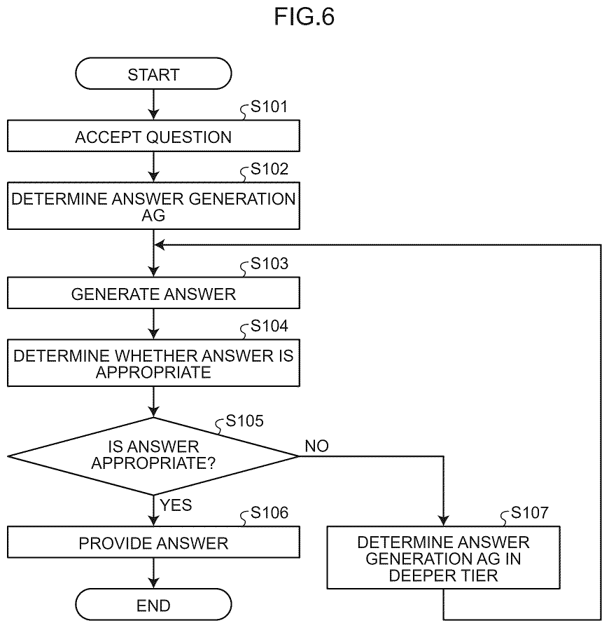

Next, with reference to FIG. 6, the processing procedure executed by the information processing device 1 according to the present embodiment is described. FIG. 6 is a flowchart illustrating the processing procedure executed by the information processing device 1 according to the present embodiment.

As illustrated in FIG. 6, the control unit 3 first accepts, from the user terminal 100, a question from a user (step S101).

Subsequently, the control unit 3 determines an answer generation AG with an answer policy that matches the accepted question (step S102).

Subsequently, the control unit 3 causes the determined answer generation AG to generate an answer to the question (step S103).

Subsequently, the control unit 3 determines whether the answer is appropriate (step S105), which is performed by determining whether the generated answer is appropriate (step S104). If the answer is appropriate (step S105: Yes), the control unit 3 provides the answer to the user terminal 100 (step S106) and terminates the processing.

On the other hand, if the answer is not appropriate (step S105: No), the control unit 3 determines an answer generation AG at a deeper tier (lower hierarchy) than the answer generation AG determined in step S102 (step S107), and returns to step S103 to regenerate an answer.

Further, among the processing operations described in the above embodiment, some of the processing operations described as being performed automatically can also be performed manually. Alternatively, all or some of the processing operations described as being performed manually can be performed automatically by a known method. In addition, the information including the processing procedures, specific names, and various types of data or parameters illustrated herein and, in the drawings, can be modified as appropriate otherwise specified. For example, the various information items illustrated in each figure are not limited to what is illustrated.

Furthermore, the individual components of the illustrated devices are functionally conceptual, and are not necessarily configured physically as illustrated in the drawings. In other words, the specific configuration of distributed or integrated functions of the respective devices is not limited to the illustrated example, and all or part of them can be functionally or physically distributed and integrated in any unit depending on various factors such as processing load or usage conditions.

For example, a part or the entirety of the storage unit 4 illustrated in FIG. 3 can be retained by a storage server or the like, rather than by each individual device. In such a case, each device acquires various types of information by accessing the storage server.

### Hardware Configuration

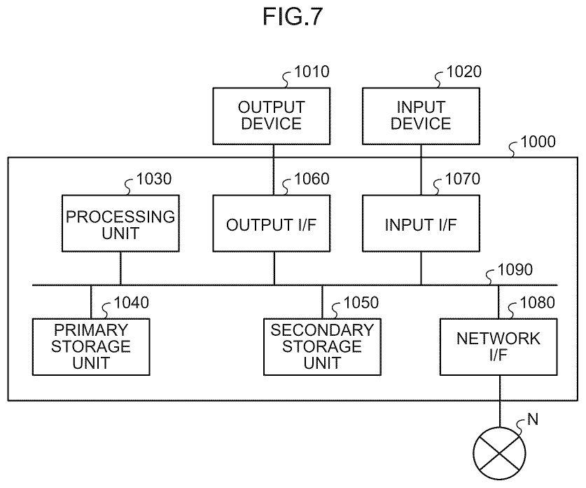

Further, the information processing device 1 according to the present embodiment described above is implemented by a computer 1000 having a configuration, for example, as illustrated in FIG. 7. FIG. 7 is a diagram illustrating an example of a hardware configuration. The computer 1000 is connected to an output device 1010 and an input device 1020, and includes a configuration in which a processing unit 1030, a primary storage unit 1040, a secondary storage unit 1050, an output interface (I/F) 1060, an input I/F 1070, and a network I/F 1080 are connected via a bus 1090.

The processing unit 1030 operates based on programs stored in the primary storage unit 1040 or the secondary storage unit 1050 or programs read from the input device 1020, and executes various processing tasks. The primary storage unit 1040 is a memory unit, such as a RAM, that temporarily stores data used by the processing unit 1030 during processing operations. The secondary storage unit 1050 is a storage unit in which data used by the processing unit 1030 for various processing operations and various databases are registered, and is implemented using a read-only memory (ROM), hard disk drive (HDD), flash memory, or the like.

The output I/F 1060 is an interface for transmitting information to be output to the output device 1010 that outputs various types of information, such as a monitor or a printer, and can be implemented using a connector conforming to standards such as universal serial bus (USB), digital visual interface (DVI), or high definition multimedia interface (HDMI, registered trademark). The input I/F 1070 is an interface for receiving information from various input devices 1020, such as a mouse, keyboard, and scanner, and can be implemented using a USB or the like.

Moreover, the input device 1020 can be a device that reads information from optical recording media such as compact disc (CD), digital versatile disc (DVD), and phase-change rewritable disk (PD); magneto-optical recording media such as magneto-optical disk (MO); tape media; magnetic recording media; or semiconductor memory. The input device 1020 can also be an external storage medium such as a USB memory.

The network I/F 1080 receives data from other devices and sends the data to the processing unit 1030 via the network N, and also transmits data generated by the processing unit 1030 to other devices via the network N.

The processing unit 1030 controls the output device 1010 and the input device 1020 via the output I/F 1060 and the input I/F 1070. For example, the processing unit 1030 can load a program from the input device 1020 or the secondary storage unit 1050 onto the primary storage unit 1040 and execute the loaded program.

For example, in the case where the computer 1000 functions as the information processing device 1, the processing unit 1030 of the computer 1000 implements the functions of the control unit 3 by executing a program loaded onto the primary storage unit 1040.

### Effects

As described above, the information processing device 1 according to the present embodiment includes the acceptance unit 31 that accepts a question from a user; the determination unit 32 that determines an answer generation agent from among a plurality of answer generation agents trained to respond based on different answer policies and linked in a hierarchical structure in accordance with a predetermined event, the selected agent being the one that corresponds to the question; and the generation unit 33 that generates an answer to the question using the determined answer generation agent.

Such a configuration, as mentioned above, allows the information processing device 1 to provide an appropriate answer to a question.

Although some of the embodiments of the present disclosure are described in detail above with reference to the drawings, such embodiments are illustrative, and the embodiments of the present disclosure can be implemented in other forms that are variously modified and improved based on the knowledge of those skilled in the art, including but not limited to the embodiments described in the disclosure of the invention.

### Other Variations

Furthermore, among the processing operations described in the above embodiments, all or part of the processing operations described as being performed automatically can be performed manually, or all or part of the processing operations described as being performed manually can be performed automatically by a known method. In addition, the information including the processing procedures, specific names, and various types of data or parameters illustrated herein and, in the drawings, can be modified as appropriate otherwise specified. For example, the various information items illustrated in each figure are not limited to what is illustrated.

Furthermore, the individual components of the illustrated devices are functionally conceptual, and are not necessarily configured physically as illustrated in the drawings. In other words, the specific configuration of distributed or integrated functions of the respective devices is not limited to the illustrated example, and all or part of them can be functionally or physically distributed and integrated in any unit depending on various factors such as processing load or usage conditions.

Furthermore, the processing operations described in the embodiments above can be combined in any manner, as long as such combinations do not result in logical inconsistency.

Additionally, the “unit” (such as section or module) described above can be replaced with terms such as “means” or “circuit”. For example, the control unit 3 can be referred to as a control means or a control circuit.

According to one aspect of an embodiment, an effect is achieved in that an appropriate answer can be provided to a question.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
an acceptance unit configured to accept a question from a user;
a determination unit configured to determine an answer generation agent that matches the question from among a plurality of answer generation agents linked in a hierarchical structure for each predetermined event, the plurality of answer generation agents each being trained to generate an answer based on a different answer policy; and
a generation unit configured to generate an answer to the question using the determined answer generation agent.

2. The information processing device according to claim 1, wherein
the determination unit is configured to
determine the answer generation agent based on the question and user information regarding the user.

3. The information processing device according to claim 2, wherein
the user information includes
a location history of the user, and
the determination unit is configured to
determine the answer generation agent based on both the question and the location history.

4. The information processing device according to claim 2, wherein
the user information includes
a question history that is a history of questions accepted from the user, and
the determination unit is configured to
determine the answer generation agent based on both the question and the question history.

5. The information processing device according to claim 1, wherein
the generation unit is configured to
determine whether the answer generated by the answer generation agent is appropriate for the question, and, in a case where the generated answer is determined to be appropriate for the question, to generate the answer as a result.

6. The information processing device according to claim 5, wherein
the determination unit is configured to
determine another answer generation agent in the case where the generation unit determines that the answer is not appropriate for the question, and
the generation unit is configured to
generate an answer to the question using the other answer generation agent.

7. The information processing device according to claim 6, wherein
the plurality of answer generation agents is
linked in a hierarchical structure such that an agent having a narrower range of answer policies is positioned at a lower tier,
the determination unit is configured to
determine a lower-tier answer generation agent in the case where the generation unit determines that the answer is not appropriate for the question, and
the generation unit is configured to
generate an answer using the lower-tier answer generation agent.

8. An information processing method executed by a computer, the method comprising:
an acceptance step of accepting a question from a user;
a determination step of determining an answer generation agent matching the question from among a plurality of answer generation agents linked in a hierarchical structure for each predetermined event, the plurality of answer generation agents each being trained to generate an answer based on a different answer policy; and
a generation step of generating an answer to the question using the determined answer generation agent.

9. A non-transitory computer-readable storage medium storing an information processing program for causing a computer to execute processing comprising:
an acceptance procedure of accepting a question from a user;
a determination procedure of determining an answer generation agent that matches the question from among a plurality of answer generation agents linked in a hierarchical structure for each predetermined event, the plurality of answer generation agents each being trained to generate an answer based on a different answer policy; and
a generation procedure of generating an answer to the question using the determined answer generation agent.
